(19) United States
(12) Patent Application Publication
(10) Pub. No.: US 2024/0118172 A1
(43) Pub. Date: Apr. 11, 2024

(54) Aircraft Sound Diagnostic Method and Device

(71) Applicant: Airbus Operations SAS, Toulouse (FR)

(72) Inventors: Marc Locheron, Toulouse (FR); Fabien Roux-Portalez, Toulouse (FR); Clothilde Martini, Toulouse (FR); Emmanuel Helffer, Toulouse (FR); Maxime Jouan, Toulouse (FR); Adil Soubki, Toulouse (FR)

(73) Assignee: Airbus Operations SAS, Toulouse (FR)

(21) Appl. No.: 18/376,116

(22) Filed: Oct. 3, 2023

(30) Foreign Application Priority Data
Oct. 10, 2022 (FR) 2210331

(51) Int. Cl. G01M 17/00; G01H 17/00

(52) U.S. Cl. CPC G01M 17/00; G01H 17/00; B64D 2045/0085

(57) ABSTRACT

An aircraft sound diagnostic method includes a step of measurement of acoustic signals by a plurality of microphones mounted at different positions inside the aircraft, a step of recording of the measured acoustic signals, a computation step which generates a sound mapping on the basis of the measured acoustic signals, a step of comparison of the sound mapping and a reference mapping and a step of transmission of the comparison to a user device. The method makes it possible to track the trending of an abnormal noise or of an abnormal noise level and assist in determining the context thereof. An aircraft sound diagnostic device for implementing the method is also described.

### FIELD OF THE INVENTION

The present invention relates to an aircraft sound diagnostic method and device.

### BACKGROUND OF THE INVENTION

Normally, before its delivery to a client or during upgrading operations, test flights are performed on an aircraft, notably a transport airplane. During these test flights, data are acquired which, once analyzed, make it possible to check whether the aircraft fulfils safety and comfort criteria.

Generally, the assessing of these criteria is based on the acquisition and the analysis, by a dedicated system, of data relating to parameters of the aircraft that are the most accurate possible. They can be parameters such as the speed, the altitude of the aircraft during the test flight, but also the noise or the vibrations inside the aircraft. The collection and the analysis of these data make it possible to decide whether improvements or corrections have to be made before the delivery or the return to service of the aircraft.

The sound level inside an aircraft is generally determined by different diagnostic methods. For example, it can be determined using a limited number of specific flights on certain aircraft. It can also be determined by recordings during a limited time using a portable recording device when an abnormal noise or an abnormal noise level is heard during a flight.

These diagnostic methods hitherto used have limitations. Indeed, having a limited number of flights with a specific flight profile can prevent the discovery of the root causes of the abnormal noise or of the abnormal noise level because a configuration of the aircraft during these specific flights may not be reproduced during a specific flight. Likewise, it can be difficult to know the context of an abnormal noise or of an abnormal noise level when a recording is made during a limited time at the moment when the abnormal noise or the abnormal noise level is heard.

The current diagnostic methods are not therefore fully satisfactory.

### BRIEF SUMMARY OF THE INVENTION

The present invention relates to an aircraft sound diagnostic method and device.

According to an aspect of the invention, the method comprises the following steps:
a step of real-time measurement of acoustic signals by a plurality of microphones intended to be mounted at different positions inside the aircraft;
a reception step, implemented by a central unit, comprising the reception of the acoustic signals measured by the microphones;
a real-time recording step, implemented by a storage unit, comprising the real-time recording of the measured acoustic signals received by the central unit;
a computation step, implemented by a computation unit, comprising the generation of a sound mapping based on the measured acoustic signals and the positions of the microphones;
a comparison step, implemented by a comparison unit, comprising the generation of a comparison mapping based on the comparison between the sound mapping and a reference mapping;
a transmission step, implemented by a transmission unit, comprising the transmission of the comparison mapping to a user device.

Thus, it is possible to track the trending of an abnormal noise or of an abnormal noise level in real time and to assist in determining the context thereof.

Advantageously, the method further comprises a step of real-time measurement of vibratory signals by a plurality of vibration sensors intended to be mounted at different positions inside the aircraft;
the reception step further comprising the reception in real time of the vibratory signals measured by the vibration sensors;
the recording step further comprising the real-time recording of the measured vibratory signals received by the central unit;
the generation of the sound mapping in the computation step being performed on the basis of the measured acoustic signals, the positions of the microphones, the measured vibratory signals and the positions of the vibration sensors.

Furthermore, the reception step comprises the real-time recording of flight parameters of the aircraft.

Advantageously, the method further comprises a display step, implemented by a display unit, comprising the real-time display of a graphic representation of at least one of the following parameters: measured acoustic signals, positions of the microphones, measured vibratory signals and positions of the vibration sensors, flight parameters of the aircraft.

Moreover, the method further comprises an uploading step, implemented by an uploading unit, comprising the uploading to the computation unit at least of the measured acoustic signals and the positions of the microphones.

In addition, the uploading step comprises the uploading to the computation unit also of the measured vibratory signals, the positions of the vibration sensors. Furthermore, the uploading step comprises the uploading to the computation unit of the flight parameters of the aircraft.

The invention relates also to an aircraft sound diagnostic device. According to an embodiment of the invention, the device comprises:
a plurality of microphones intended to be mounted at different positions inside the aircraft, each of the microphones being configured to measure in real time an acoustic signal;
a central unit configured to receive the acoustic signals measured by the microphones;
a storage unit configured to record in real time the measured acoustic signals received by the central unit;
a computation unit configured to generate a sound mapping on the basis of the measured acoustic signals and the positions of the microphones;
a comparison unit configured to generate a comparison mapping on the basis of the comparison between the sound mapping and a reference mapping;
a transmission unit configured to transmit the comparison mapping to a user device.

Advantageously, the device further comprises a plurality of vibration sensors intended to be mounted at different positions inside the aircraft, each of the vibration sensors being configured to measure in real time vibratory signals,
the central unit being configured also to receive in real time the vibratory signals measured by the vibration sensors;
the storage unit being configured to record in real time the measured vibratory signals received by the central unit;
the computation unit being configured to generate a sound mapping on the basis of the measured acoustic signals, the positions of the microphones, the measured vibratory signals and the positions of the vibration sensors.

Furthermore, the central unit is configured also to receive in real time flight parameters of the aircraft.

Advantageously, the device further comprises a display unit configured to display in real time a graphic representation of at least one of the following parameters: measured acoustic signals, positions of the microphones, measured vibratory signals and positions of the vibration sensors, flight parameters of the aircraft.

Moreover, the device further comprises an uploading unit configured to upload to the computation unit at least the measured acoustic signals and the positions of the microphones.

In addition, the uploading unit is configured to upload to the computation unit also the measured vibratory signals and the positions of the vibration sensors.

Furthermore, the uploading unit is configured to upload to the computation unit the flight parameters of the aircraft.

### BRIEF DESCRIPTION OF THE DRAWINGS

The attached figures will give a good understanding as to how the invention can be implemented. In these figures, identical references designate similar elements.

FIG. 1 is a schematic view of the sound diagnostic device.

FIG. 2 represents two top views (a) and (b) of the interior of aircraft cabins onboard which the plurality of microphones and vibration sensors are installed.

FIG. 3 is a schematic flow diagram of the sound diagnostic method.

### DETAILED DESCRIPTION

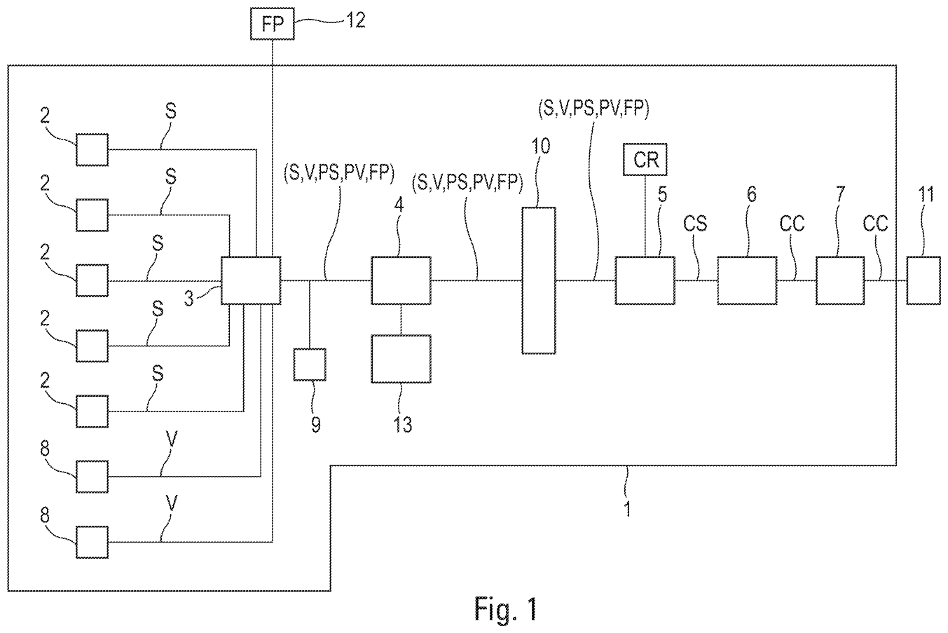

The sound diagnostic device 1 of an aircraft AC (hereinafter called “device 1”) is schematically represented in FIG. 1.

The device 1 comprises at least a plurality of microphones 2, a central unit 3, a storage unit 4, a computation unit 5, a comparison unit 6 and a transmission unit 7.

The microphones 2 of the plurality of microphones 2 are intended to be mounted at different positions PS inside the aircraft AC. Each of the microphones 2 is configured to measure in real time an acoustic signal S.

For example, the microphones 2 are based on the technology of the microelectromechanical systems MEMS. They can be each encapsulated in mechanical and electronic strips. These strips can then be mounted on supports fixed at the different positions PS inside the aircraft AC.

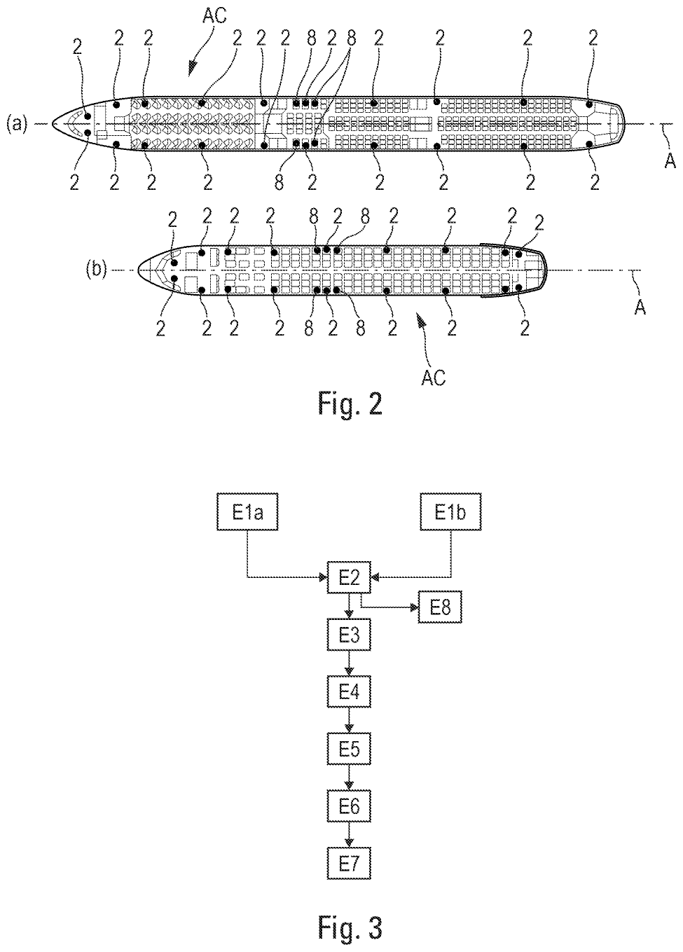

FIG. 2 represents two different aircraft AC each illustrating two examples (a) and (b) of distribution of the positions PS of the microphones 2. As represented in these two figures (a) and (b), the microphones 2 can be distributed symmetrically with respect to a vertical plane A of symmetry of the aircraft AC. As a nonlimiting example, the plurality of microphones 2 comprises from twenty to thirty microphones 2. In the examples of FIG. 2, the plurality of microphones 2 comprises twenty microphones 2. In these examples, eight microphones can be installed at the eight doors of the aircraft AC symmetrically with respect to the vertical plane A of symmetry: at the main doors and at the overwing evacuation exits. Two microphones can be installed in the cockpit symmetrically: in the seat of the pilot and in the seat of the copilot. Ten microphones can be installed in the cabin of the aircraft AC symmetrically: at the first row of seats, at the last row of seats and spaced evenly between the first row of seats and the second row of seats.

According to a variant, the microphones are positioned randomly inside the aircraft AC.

The central unit 3 is configured to receive the acoustic signals S measured by the microphones 2. Each acoustic signal S can be associated with the position PS in the aircraft AC of the microphone 2 having picked up the acoustic signal S. The central unit 3 can receive the acoustic signals S from the microphones 2 via a wireless link, of Wi-Fi type.

The storage unit 4 is configured to record in real time the measured acoustic signals S received by the central unit 3. The storage unit 4 can also store the position PS of each of the microphones 2 having picked up each of the acoustic signals S respectively.

The computation unit 5 is configured to generate a sound mapping CS on the basis of the measured acoustic signals S and the positions PS of the microphones 2. A sound mapping can correspond to a two-dimensional or three-dimensional representation of noise levels (for example expressed in decibels). The computation unit 5 therefore makes it possible to obtain a sound mapping CS as a function of time based on the real-time measurements. The trend over time of the noises onboard the aircraft AC can therefore be observed from this sound mapping CS.

The comparison unit 6 is configured to generate a comparison mapping CC based on a comparison between the sound mapping CS and a reference mapping CR.

As an example, the reference mapping CR can correspond to a sound mapping performed by learning over a predetermined number of aircraft. It can also correspond to a two-dimensional or three-dimensional sound mapping, determined on the basis of a digital model.

The comparison mapping CC can correspond to a two-dimensional or three-dimensional mapping comprising ratios between the sound mapping CS and the reference mapping CR. The comparison unit 6 therefore makes it possible to obtain a comparison mapping CC as a function of time based on the sound mapping CS. The trend over time of the noises onboard the aircraft AC can therefore also be observed from this comparison mapping CC.

The transmission unit 7 is configured to transmit the comparison mapping CC to a user device 11. In a nonlimiting manner, the user device 11 can correspond to a data processing device or to a display device making it possible to view the comparison mapping.

Advantageously, the device 1 further comprises a plurality of vibration sensors 8 intended to be mounted at different positions PV inside the aircraft AC. Each of the vibration sensors 8 is configured to measure in real time vibratory signals V. For example, the vibration sensors 8 correspond to accelerometers.

The two examples (a) and (b) of FIG. 2 each represents a distribution of the positions PV of the vibration sensors 8. As represented in these two figures (a) and (b), the vibration sensors 8 can be distributed symmetrically with respect to a vertical plane A of symmetry of the aircraft AC. As a nonlimiting example, the plurality of vibration sensors 8 comprises four vibration sensors 8. In this example, the four vibration sensors 8 are distributed mid-way between the two ends of the cabin. Two of these four vibration sensors 8 are intended to measure the vibrations produced by the engines. The other two vibration sensors 8 are intended to measure the vibrations at the wing fuselage fairings which facilitate the flow of air at the wing root fairing of the aircraft AC.

The central unit 3 is then configured to also receive in real time the vibratory signals V measured by the vibration sensors 8. Each vibratory signal V can be associated with the position PV in the aircraft AC of the vibration sensor 8 having picked up the vibratory signal V. The central unit 3 can receive the vibratory signals V from the vibration sensors 8 via a wireless link, of Wi-Fi type.

Similarly, the storage unit 4 is then configured to record in real time the measured vibratory signals V received by the central unit 3. The storage unit 4 can also store the position PV of each of the vibration sensors 8 having each picked up vibratory signals V respectively.

The computation unit 5 is configured to generate a sound mapping CS on the basis of the measured acoustic signals S, the positions PS of the microphones 2, the measured vibratory signals V and the positions PV of the vibration sensors 8.

The computation unit 5 can use the vibratory signals V and the position of the vibration sensors 8 to filter the acoustic signals S which are caused by normal vibrations.

The computation unit 5 makes it possible to obtain a sound mapping CS as a function of time. The trend over time of the noises onboard the aircraft AC can therefore be observed.

The central unit 3 can also be configured to receive in real time flight parameters FP of the aircraft AC. These flight parameters can correspond in particular to the altitude, the speed and the pressure of the aircraft AC. They can be acquired by the central unit 3 via an avionics bus 12 or else via a wireless telecommunication link allowing the short-distance two-way exchange of data of Bluetooth type. The storage unit 4 is then configured to record in real time the flight parameters FP received by the central unit 3.

The storage unit 4 can be connected to a clock 13 (for example of NTP server type) intended to synchronize the data (acoustic signals S, positions PS of the microphones 2, vibratory signals V, positions PV of the vibration sensors 8, flight parameters FP, etc.) recorded in the storage unit 4. The storage unit 4 can be connected to the clock 13 via a wireless link, of Wi-Fi type.

The device 1 can further comprise a display unit 9 configured to display in real time a graphic representation of at least one of the following parameters: measured acoustic signals S, positions PS of the microphones 2, measured vibratory signals V and positions PV of the vibration sensors 8, flight parameters FP of the aircraft AC.

In a first embodiment, the central unit 3, the storage unit 4, the computation unit 5, the comparison unit 6 and the transmission unit 7 are intended to be installed on board the aircraft AC.

In a second embodiment, the central unit 3 and the storage unit 4 are intended to be installed onboard the aircraft AC. The computation unit 5, the comparison unit 6 and the transmission unit 7 are intended to be installed on the ground. In this second embodiment, the device 1 further comprises an uploading unit 10 configured to upload to the computation unit 5 at least the measured acoustic signals S and the positions PS of the microphones 2. It can also be configured to upload to the computation unit 5 the measured vibratory signals V and the positions PV of the vibration sensors 8. It can also be configured to upload to the computation unit 5 the flight parameters FP of the aircraft AC. The uploading unit 10 can upload these parameters when the aircraft AC is on the ground. The uploading unit 10 can be connected to the computation unit 5 via a wired link.

In a third embodiment, the central unit 3, the storage unit 4, the computation unit 5 are intended to be installed onboard the aircraft AC. The comparison unit 6 and the transmission unit 7 are intended to be installed on the ground.

The invention relates also to an aircraft AC sound diagnostic method (FIG. 3).

The method comprises the following steps:
a step Ela of real-time measurement of acoustic signals S by the plurality of microphones;
a reception step E2, implemented by the central unit 3, comprising the reception of the acoustic signals S measured by the microphones 2;
a real-time recording step E3, implemented by the storage unit 4, comprising the real-time recording of the measured acoustic signals S received by the central unit 3;
a computation step E5, implemented by the computation unit 5, comprising the generation of the sound mapping CS on the basis of the measured acoustic signals S and the positions PS of the microphones 2;
a comparison step E6, implemented by the comparison unit 6, comprising the generation of the comparison mapping CC on the basis of a comparison between the sound mapping CS and the reference mapping CR;
a transmission step E7, implemented by the transmission unit 7, comprising the transmission of the comparison mapping CC to the user device 11.

The method can further comprise a step E1b of real-time measurement of vibratory signals V by the plurality of vibration sensors 8. In this case, the reception step E2 further comprises the real-time reception of the vibratory signals V measured by the vibration sensors. The recording step E3 further comprises the real-time recording of the measured vibratory signals V received by the central unit 3. The generation of the sound mapping CS in the computation step E4 is performed on the basis of the measured acoustic signals S, the positions PS of the microphones 2, the measured vibratory signals V and the positions PV of the vibration sensors 8.

The reception step E2 can further comprise the real-time recording of flight parameters FP of the aircraft AC.

The method can further comprise a display step E8, implemented by the display unit 9, comprising the real-time display of a graphic representation of at least one of the following parameters: measured acoustic signals S, positions PS of the microphones 2, measured vibratory signals V, positions PV of the vibration sensors 8, flight parameters FP of the aircraft AC. In one embodiment, the display step E8 follows the reception step E2.

According to the second embodiment, the method further comprises an uploading step E4, implemented by the uploading unit 10, comprising the uploading to the computation unit 5 at least of the measured acoustic signals S in the positions PS of the microphones 2.

The uploading step E4 can comprise the uploading to the computation unit 5 also of the measured vibratory signals V, the positions PV of the vibration sensors 8. The uploading step E4 can comprise the uploading to the computation unit 5 also of the flight parameters FP of the aircraft AC.

The device 1 can use different applications.

In particular, during a flight, the crew members generally use a handheld microphone system in order to perform noise recordings. These recordings last approximately 30 seconds and are taken at the point where the crew members hear the noises and at the point where they judge to have found the source of the noises. The presence of the device 1 makes it possible to obtain more information such as the context of the noise. For example, the device makes it possible to know whether other noises have occurred before the start of the recordings made by the crew members using the handheld microphone system.

In another application, the device 1 makes it possible to ensure that each aircraft of a same type has a same sound mapping.

In another application, the device 1 also makes it possible to check over a given time the trend of a particularly sensitive system or a system that is known to be noisy. In this case, a routine monitoring can be performed on a particular microphone 2 (for example, close to the system on which the trend is being monitored). This routine monitoring makes it possible to study the sound trend of the system. An alert can then be launched if the system becomes too noisy.

In another application, the device 1 can be used to compare noise levels between two different aircraft operating in identical conditions or else to decide if a noise level in an aircraft AC is acceptable for an airline. The noise levels can be measured by the plurality of microphones 2 or a part of the plurality of microphones 2 in a zone of the aircraft AC.

In another application, the sound mapping obtained by the device 1 can be used to generalize the monitoring of all the aircraft AC of a fleet. Said mapping makes it possible to know the silent zones and the noisy zones in order to find solutions to reduce these noisy zones. It also makes it possible to ensure that there is no acoustic drift in the fleet or that there is no occurrence of new noises with time. It also allows for the “crisis” periods to be explained when similar noises appear most frequently.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft sound diagnostic method comprising:
a step of real-time measurement of acoustic signals by a plurality of microphones mounted at different positions inside the aircraft;
a reception step, implemented by a central unit, comprising reception of the acoustic signals measured by the microphones;
a real-time recording step, implemented by a storage unit, comprising real-time recording of the measured acoustic signals received by the central unit;
a computation step, implemented by a computation unit, comprising a generation of a sound mapping based on the measured acoustic signals and on the positions of the microphones;
a comparison step, implemented by a comparison unit, comprising a generation of a comparison mapping based on a comparison between the sound mapping and a reference mapping; and
a transmission step, implemented by a transmission unit, comprising a transmission of the comparison mapping to a user device.

2. The method as claimed in claim 1, further comprising:
a step of real-time measurement of vibratory signals by a plurality of vibration sensors mounted at different positions inside the aircraft;
wherein the reception step further comprises real-time reception of the vibratory signals measured by the vibration sensors;
wherein the recording step further comprises real-time recording of the measured vibratory signals received by the central unit;
wherein the generation of the sound mapping in the computation step is performed on the basis of the measured acoustic signals, the positions of the microphones, the measured vibratory signals and the positions of the vibration sensors.

3. The method as claimed in claim 1,
wherein the reception step further comprises real-time recording of flight parameters of the aircraft.

4. The method as claimed in claim 1, further comprising:
a display step, implemented by a display unit, comprising real-time display of a graphic representation of at least one of the following parameters: measured acoustic signals, positions of the microphones, measured vibratory signals, positions of the vibration sensors, or the flight parameters of the aircraft.

5. The method as claimed in claim 1, further comprising:
an uploading step, implemented by an uploading unit, comprising uploading to the computation unit at least one of the measured acoustic signals and the positions of the microphones.

6. The method as claimed in claim 1,
wherein the uploading step further comprises uploading to the computation unit of the measured vibratory signals and the positions of the vibration sensors.

7. The method as claimed in claim 1,
wherein the uploading step further comprises uploading to the computation unit of the flight parameters of the aircraft.

8. An aircraft sound diagnostic device, comprising:
a plurality of microphones configured to be mounted at different positions inside the aircraft, each of the plurality of microphones configured to measure in real time an acoustic signal;
a central unit configured to receive the acoustic signals measured by the plurality of microphones;
a storage unit configured to record in real time the measured acoustic signals received by the central unit;
a computation unit configured to generate a sound mapping on the basis of the measured acoustic signals and the positions of the microphones;
a comparison unit configured to generate a comparison mapping based on a comparison between the sound mapping and a reference mapping; and
a transmission unit configured to transmit the comparison mapping to a user device.

9. The device as claimed in claim 8, further comprising:
a plurality of vibration sensors configured to be mounted at different positions inside the aircraft, each of the plurality of vibration sensors configured to measure in real time vibratory signals,
wherein the central unit is further configured to receive in real time the vibratory signals measured by the vibration sensors;
wherein the storage unit is further configured to record in real time the measured vibratory signals received by the central unit; and
wherein the computation unit is configured to generate a sound mapping on the basis of the measured acoustic signals, the positions of the microphones, the measured vibratory signals and the positions of the vibration sensors.

10. The device as claimed in claim 8,
wherein the central unit is further configured to receive in real time flight parameters of the aircraft.

11. The device according to claim 8, further comprising:
a display unit configured to display in real time a graphic representation of at least one of the following parameters: measured acoustic signals, positions of the microphones, measured vibratory signals, positions of the vibration sensors, or the flight parameters of the aircraft.

12. The device as claimed in claim 8, further comprising:
an uploading unit configured to upload to the computation unit at least the measured acoustic signals and the positions of the microphones.

13. The device as claimed in claim 8,
wherein the uploading unit is further configured to upload to the computation unit the measured vibratory signals and the positions of the vibration sensors.

14. The device as claimed in claim 8,
wherein the uploading unit is further configured to upload to the computation unit the flight parameters of the aircraft.
